(19) United States
(12) Patent Application Publication
(10) Pub. No.: US 2019/0005038 A1
(43) Pub. Date: Jan. 3, 2019

(54) METHOD AND APPARATUS FOR GROUPING DOCUMENTS BASED ON HIGH-LEVEL FEATURES CLUSTERING

(71) Applicant: Xerox Corporation, Norwalk, CT (US)

(72) Inventors: Jerome Pouyadou, Grenoble (FR); Yves Hoppenot, Notre Dame de Message (FR)

(21) Appl. No.: 15/639,541

(22) Filed: Jun. 30, 2017

(51) Int. Cl. G06F 17/30

(52) U.S. Cl. CPC G06F 17/3028; G06F 17/30253; G06F 17/3007; G06F 17/30011

(57) ABSTRACT

A method and apparatus for creating a file directory of documents in a database that are clustered based on one or more high level features are disclosed. For example, the method includes identifying the one or more high level features for each one of a plurality of documents stored in the database, comparing the one or more high level features of the each one of the plurality of documents to other documents of the plurality of documents, grouping documents of the plurality of documents into a plurality of clusters based on common high level features that are identified in the comparing and creating the file directory of documents in the database based on the plurality of clusters.

The present disclosure relates generally to storage of documents in memory and, more particularly, to a method and apparatus for grouping documents based on high-level features clustering.

### BACKGROUND

Businesses have transitioned from keeping paper files to digital documents. The number of digital documents that are kept by businesses have exploded in recent years. Occasionally, the business may exercise information system assessments so as to know what documents are kept. The information system assessments may help to reduce storage, rationalize workflows, optimize printer usage, and the like.

The information system assessments can consume volumes of printed pages and large amounts of hardware resources. Current methods for performing the information system assessments may include grouping documents simply by a file extension name (e.g., “.docx” for a Word document, “.pdf” for a portable document file, and the like) or by using classical image clustering algorithms.

The classical image clustering algorithms exploit low-level graphical features (e.g., windows of a few pixels wide subject to various adaptations) to represent the image through feature vectors. Similarity between two images may then be computed (e.g., by using a simple dot product of both feature vectors). Performing these computations can consume large amounts of processing power and resources.

Since these approaches use low-level graphical features initially designed for natural images, they are not well adapted to visual representations of documents. For example, the classical image clustering algorithms may give the same importance to all pixels on a page. In addition, the classical image clustering algorithms are performed without having any particular meaning to a human brain, which may make the classical image clustering algorithms difficult to debug.

### SUMMARY

According to aspects illustrated herein, there are provided a method, non-transitory computer readable medium and apparatus for creating a file directory of documents in a database that are clustered based on one or more high level features. One disclosed feature of the embodiments is a method that identifies the one or more high level features for each one of a plurality of documents stored in the database, compares the one or more high level features of the each one of the plurality of documents to other documents of the plurality of documents, groups documents of the plurality of documents into a plurality of clusters based on common high level features that are identified in the comparing and creates the file directory of documents in the database based on the plurality of clusters.

Another disclosed feature of the embodiments is a non-transitory computer-readable medium having stored thereon a plurality of instructions, the plurality of instructions including instructions which, when executed by a processor, cause the processor to perform operations that identify the one or more high level features for each one of a plurality of documents stored in the database, compare the one or more high level features of the each one of the plurality of documents to other documents of the plurality of documents, group documents of the plurality of documents into a plurality of clusters based on common high level features that are identified in the comparing and create the file directory of documents in the database based on the plurality of clusters.

Another disclosed feature of the embodiments is an apparatus comprising a processor and a computer-readable medium storing a plurality of instructions which, when executed by the processor, cause the processor to perform operations that identify the one or more high level features for each one of a plurality of documents stored in the database, compare the one or more high level features of the each one of the plurality of documents to other documents of the plurality of documents, group documents of the plurality of documents into a plurality of clusters based on common high level features that are identified in the comparing and create the file directory of documents in the database based on the plurality of clusters.

### BRIEF DESCRIPTION OF THE DRAWINGS

The teaching of the present disclosure can be readily understood by considering the following detailed description in conjunction with the accompanying drawings, in which:

FIG. 1 illustrates a block diagram of an example computing system of the present disclosure;

FIG. 2 illustrates an example process flow diagram of the present disclosure;

FIG. 3 illustrates an example feature of a spot title of the present disclosure;

FIG. 4 illustrates a second example feature of a spot title of the present disclosure;

FIG. 5 illustrates an example feature of an address field of the present disclosure;

FIG. 6 illustrates an example feature of an icon of the present disclosure;

FIG. 7 illustrates an example feature of a border area of the present disclosure;

FIG. 8 illustrates an example feature of a table of the present disclosure;

FIG. 9 illustrates an example feature of a text flow of the present disclosure;

FIG. 10 illustrates an example of clustering of the present disclosure;

FIG. 11 illustrates a flow diagram of an example method for creating a file directory of documents in a database that are clustered based on one or more high level features; and

FIG. 12 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses a method and apparatus for creating a file directory of documents in a database that are clustered based on one or more high level features. As discussed above, businesses have transitioned from keeping paper files to digital documents. The number of digital documents that are kept by businesses have exploded in recent years. Occasionally, the business may exercise information system assessments so as to know what documents are kept. The information system assessments may help to reduce storage, rationalize workflows, optimize printer usage, and the like. However the information system assessments performed today can consume volumes of printed pages and large amounts of hardware resources.

Embodiments of the present disclosure provide a method that can extract high level features that can be used to cluster documents. The use of the high level features of the present disclosure consumes less processing power then currently deployed methods that are described above. In addition, the embodiments of the present disclosure automatically creates a file directory in a database of the clustered documents. Thus, a user may then label each file that stores documents that are clustered and use the created file directory for efficient information system assessment.

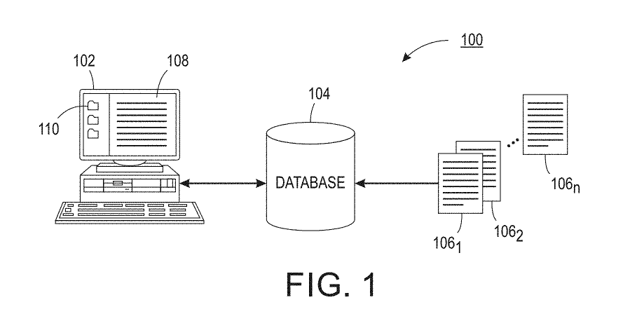

FIG. 1 illustrates an example computing system 100 of the present disclosure. In one embodiment, the computing system 100 may include an endpoint device 102 and a database (DB) 104. The endpoint device 102 may be a computing device with a processor and a memory that stores instructions that are executed by the processor to perform the functions described herein. The endpoint device 102 may be a desktop computer, a laptop computer, a tablet computer, and the like.

In one embodiment, the DB 104 may be a mass storage device or a database server. In one embodiment, the DB 104 may store a plurality of documents 106₁ to 106ₙ (hereinafter after referred to individually as a document 106 or collectively as documents 106). The documents 106 may be electronic documents, or digital documents, such as a word processing document, a portable document file (PDF), an image of a document, and the like.

In one embodiment, the endpoint device 102 may be communicatively coupled to the DB 104 via a wired or wireless connection. The DB 104 may be located remotely (e.g., a different building, a different geographic location, a different communication network, and the like) from the endpoint device 102.

In one embodiment, the documents 106 may be stored in the DB 104 in an unordered or unorganized file system. For example, the documents 106 may be saved within a single file or location within the DB 104 by date order of when the document was created or modified.

The endpoint device 102 of the present disclosure may be modified or configured to automatically identify high level features in the documents 106, compare the high level features of each one of the documents 106 to create clusters of documents 106, and create a file directory 110 in a graphical user interface (GUI) 108 of the endpoint device 102. The file directory 110 may be organized based on the clusters of documents 106 that are created. As a result, information system assessments can be easily performed based on the file directory 110 of the clusters of documents 106 created in the DB 104, rather than the entire unorganized storage of documents 106 in the DB 104.

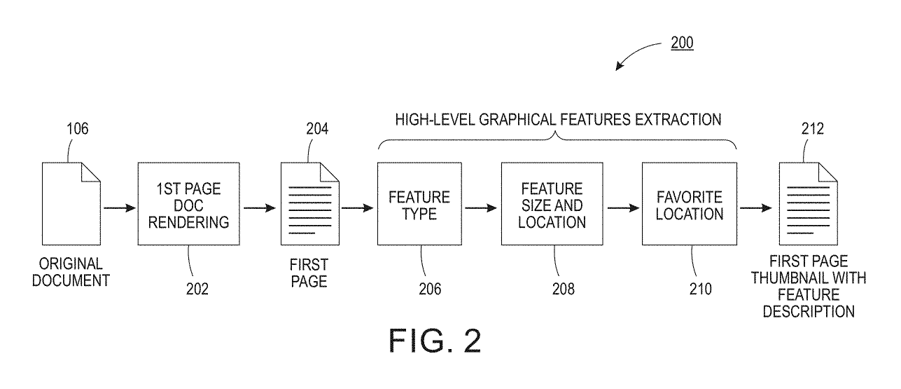

FIG. 2 illustrates an example process flow 200 of the present disclosure. In one embodiment, the documents 106 may be each obtained from the DB 104, analyzed, and processed by the by the endpoint device 102. In one embodiment, only the first page of each document 106 may be analyzed. As a result, even if the documents 106 contain several pages, the endpoint device 102 may cluster the documents based on processing and analysis of only the first page of each respective document 106.

In one embodiment, the document 106 may be rendered by the endpoint device 102 at block 202. In one example, rendering may include converting the document 106 into a format that can be used to extract high level features of the document 106. One example format may be a portable network graphics (.png file). The .png file may be a raster graphics file format that supports lossless data compression.

After the document 106 is rendered, the process flow 200 may perform high level feature extraction that includes blocks 206, 208, and 210. At block 206, portions of the document 106 may be analyzed using a segmentation algorithm. For example, the segmentation algorithm may analyze groups of pixels of the document 106 within a window having a predefined size (e.g., 10 pixels×10 pixels, 100 pixels×100 pixels, and the like). Possible high level features may be identified in each segment of the first page of the document 106 that is analyzed.

At block 208, various information about each possible high level feature is calculated. For example, the size of text, images, or other graphical elements of the high level feature may be calculated. In addition, a location of the text or images relative to an origin may be calculated. The origin may be the top left corner of each document 106.

At block 210, a single high level feature for each segment of the document 106 that contains possible high level features may be identified based on a favorite location of the high level features and the location calculated in block 208. For example, a segment at a top center of the document 106 may be a first high level feature or a second high level feature. The first high level feature may have large text and have a favorite location at a center top third of the document 106. The second high level feature may have small text and have a favorite location at a top right corner of the document 106. The endpoint device 102 may determine that the image or the text in the segment at the top center of the document 106 is the first high level feature based on the rules and favorite location associated with the first high level feature.

In some embodiments, a single high level feature may still not be identified based on the rules and locations of the possible high level features. In other words, two different rules of the predefined rules that are associated with the different high level features may be equally applicable to a high level feature that is detected within a segment of the document 106. In such instances, a predefined priority level associated with each one of a plurality of high level features may be used to identify the high level feature.

For example, some high level features may be prioritized over other high level features in an ordered list. Thus, when the single high level feature cannot be identified based on the rules and locations of the possible high level features, the high level feature may be identified based on the predefined set of rules identified with a high level feature that has a higher, or highest, pre-defined priority level.

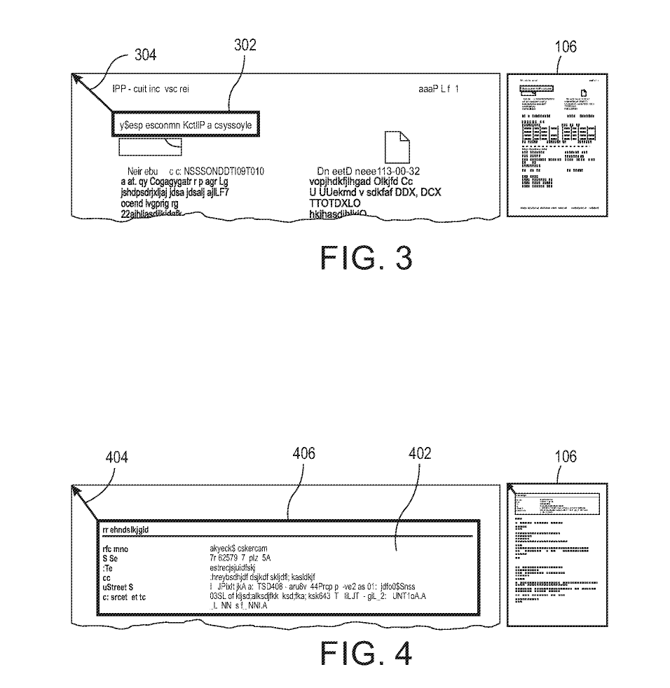

In one embodiment, the order of the high level features in FIG. 3-9 may be the order of priority of the high level features. For example, the spot title may have higher priority over the address field, the address field may have higher priority over a margin icon, and so forth.

It should be noted that blocks 206, 208, and 210 illustrate one example of a rules based extraction of high level features. In other embodiments, a training model trained using deep learning algorithms or a neural network may also be used. For example possible high level features may be compared to training models to identify the possible high level feature in different segments of the document 106.

At block 212, a thumbnail image may be created of a first page of the document 106 that includes a description of the high level features contained in the document 106. The thumbnail image 212 may be used to display the documents 106 within each cluster that is organized in the file directory 110 displayed in the GUI 108. For example, the thumbnail image 212 may provide a user a quick summary of high level features found each document 106.

In one embodiment, the process flow 200 may be repeated for each document 106 stored in the DB 104. In one embodiment, the process flow 200 may be performed periodically to organize new documents 106 that are added over time. In another embodiment, the process flow 200 may be performed on demand when requested by a user via the endpoint device 102.

As noted above, various different high level features may be extracted. The present disclosure uses high level features (e.g., groups of pixel analysis such as text, entire images, and the like) as opposed to other algorithms that use low level features (e.g., pixel level analysis). FIGS. 3-9 illustrate different examples of high level features that can be identified and rules associated with each high level feature.

FIG. 3 illustrates an example of a high level feature of a spot title 302. The spot title 302 is shown relative to the first page of the entire document 106. In one embodiment, the spot title 302 may be a graphical element that has a prominent word or short group of words (e.g., 10 words or less). The spot title 302 may have a large text (e.g., 14 point font or larger) and have a favorite location that is located at a portion of a top third of the page (e.g., a left top third, a middle top third, or a right top third). The top third of the page may be measured relative to an origin (e.g., the top left corner of the page) as shown by the arrow 304.

FIG. 4 illustrates another example of a high level feature of a spot title 402. The spot title 402 is shown relative to the first page of the entire document 106. In one embodiment, the spot title 402 may be a graphical element that has a bounding box 406 that includes large groups of words (e.g., more than one line of text within the bounding box 406). The spot title 402 may have text that is approximately 10-14 point font size and have a favorite location that is located across an entire top third of the page. The top third of the page may be measured relative to an origin (e.g., the top left corner of the page) as shown by the arrow 404.

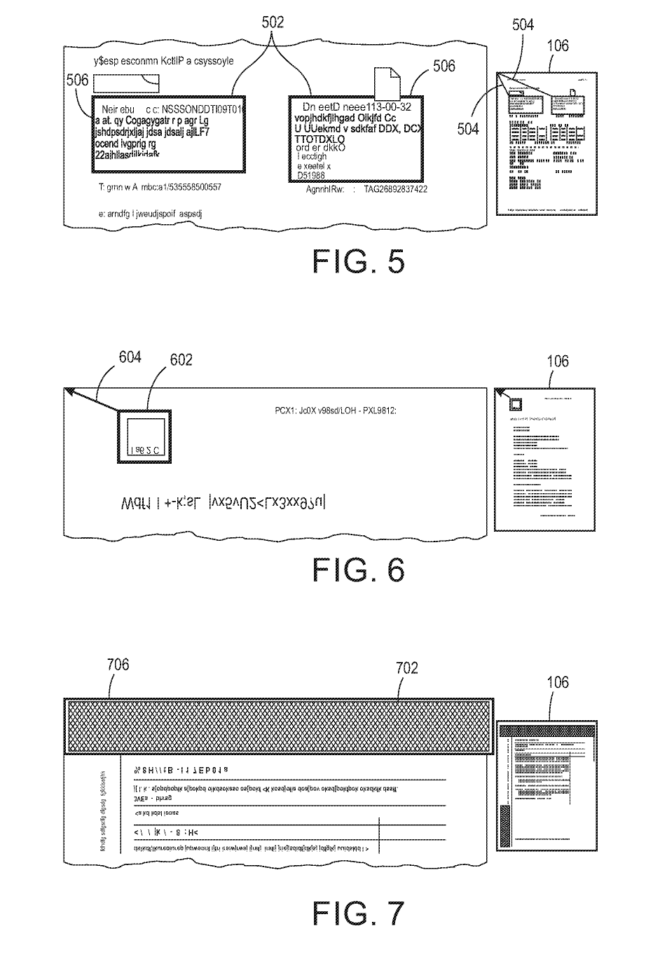

FIG. 5 illustrates an example of a high level feature of an address field 502. The address field 502 is shown relative to the first page of the entire document 106. In one embodiment, the address field 502 may be a graphical element that has a text associated with an address or a location and may be located within a bounding box 506. The text within the bounding box 506 may be formatted to have a left alignment or a right alignment. The address field 502 may have text that is approximately 10-14 point font size and have a favorite location that is located at top third of the page. The top third of the page may be measured relative to an origin (e.g., the top left corner of the page) as shown by the arrows 504 on the document 106.

FIG. 6 illustrates an example of a high level feature of a margin icon 602. The margin icon 602 is shown relative to the first page of the entire document 106. In one embodiment, the margin icon 602 may be a graphical element that includes letters or an image associated with a logo of a company. The margin icon 602 may be located in a margin of the document or near the top margin or the bottom margin of a page. In one embodiment, the margin icon 602 may have a favorite location that is located near a corner of the top margin or the bottom margin of the page. The top of the page may be measured relative to an origin (e.g., the top left corner of the page) as shown by the arrows 604.

FIG. 7 illustrates an example of a high level feature of a border area 702. The border area 702 is shown relative to the first page of the entire document 106. In one embodiment, the border area 702 may be a graphical element that does not contain any text and may include a bounding box 706. The border area 702 may have a favorite location that is located at top third of the page within several centimeters of an edge of the page (e.g., a top edge, a left edge, a right edge, or a bottom edge).

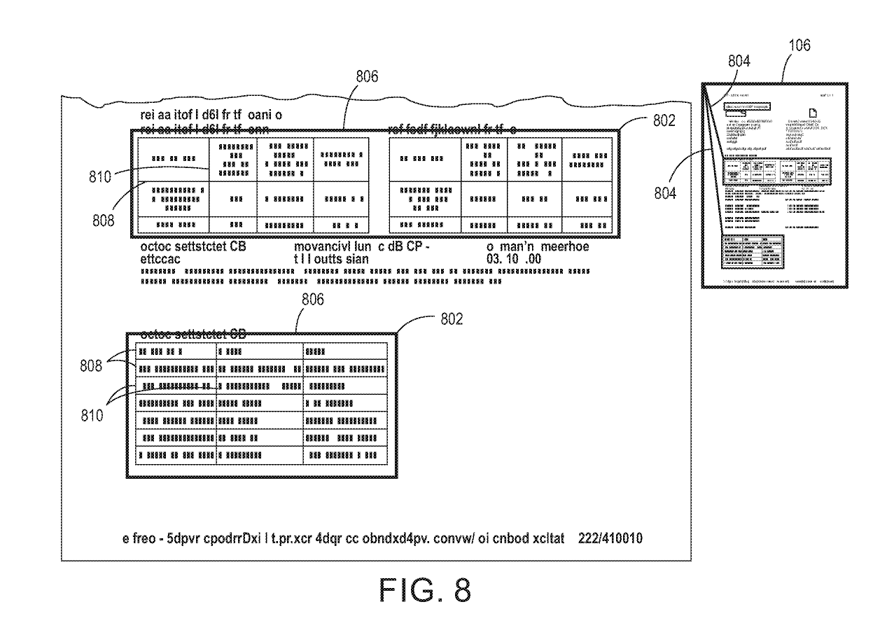

FIG. 8 illustrates an example of a high level feature of a table 802. The table 802 is shown relative to the first page of the entire document 106. In one embodiment, the table 802 may be a graphical element that has a border area 806. The border area 806 may include additional horizontal lines 808 and vertical lines 810 that intersect to form cells that may contain text or other information. The table 802 may be located after a top third of the page. For example, the table 802 may have a favorite location that is located within a middle third or a bottom third of the page. The top third, middle third or the bottom third of the page may be measured relative to an origin (e.g., the top left corner of the page) as shown by the arrows 804 on the document 106.

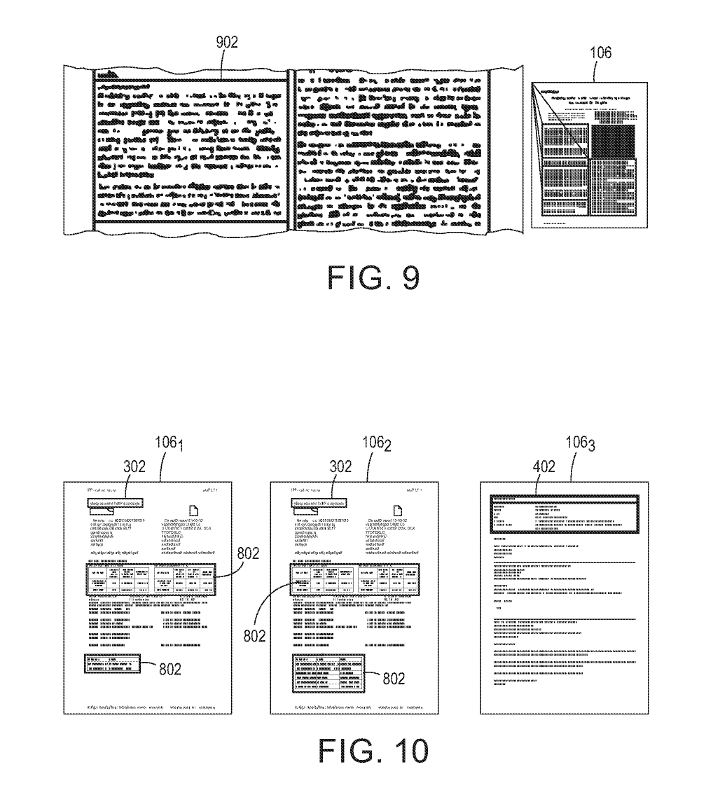

FIG. 9 illustrates an example of a high level feature of a text flow 902. The text flow 902 is shown relative to the first page of the entire document 106. In one embodiment, the text flow 902 may be a graphical element that includes text in a paragraph form or in columns. The size of the text in the text flow 902 may have a same font size. The text flow 902 may have text that has an approximately 10-14 point font size. The text flow 902 may have alignment features such as alignment left, right or center. The text flow 902 may be located after a top third of the page. The text flow 902 may be located anywhere in the first page of the document 106 and not be associated with a favorite location.

It should be noted that the high level features illustrated in FIGS. 3-9 are provided as examples. Other high level features may be identified or used. It should be noted that the high level features are not identified based on a pixel level analysis. Rather, the high level features are based on rules associated with graphical elements (e.g., large groups of pixels) within a segment or portion of the first page of the document 106.

FIG. 10 illustrates an example of clustering of the present disclosure. For example, after the high level features (e.g., one or more of the features illustrated in FIGS. 3-9) are identified (e.g., blocks 206, 208, and 210 of the process flow 200) in each one of the documents 106₁ to 106ₙ the documents may be clustered. For example, FIG. 10 illustrates an example using three documents 106₁, 106₂ and 106₃. In one embodiment, the document 106₁ may be compared to each one of the other documents 106₂ and 106₃. In one example, the document 106₁ includes a spot title 302 and two tables 802. The document 106₂ may include a spot title 302 and two tables 802. Thus, when the document 106₁ is compared to the document 106₂, the two documents 106₁ and 106₂ may be clustered as they have the same number and type of high level features.

The document 106₃ may include a spot title 402. Thus, when the document 106₁ is compared to the document 106₃, the two documents 106₁ and 106₃ may not be clustered together since the documents 106₁ and 106₃ have different high level features.

As a result, the file directory 110 may be created that includes a first folder with the documents 106₁ and 106₂ and a second folder that includes only the document 106₃. In one embodiment, when a user selects the first folder, the thumbnails 212 associated with the documents 106₁ and 106₂ may appear in the first folder. Thus, the clustering of the documents 106₁ and 106₂ may allow a user to know that the documents 106₁ and 106₂ are similar types of documents that can be managed as desired. For example, duplicate documents within may be deleted within the first folder. In another example, all the documents 106 within a cluster may be deleted by simply deleting the first folder within the file directory 110 rather than searching for each type of document one-by-one within the DB 104. A similar comparison may be made with all of the documents 106₁ to 106ₙ until all of the 106ₙ documents are clustered, as described above.

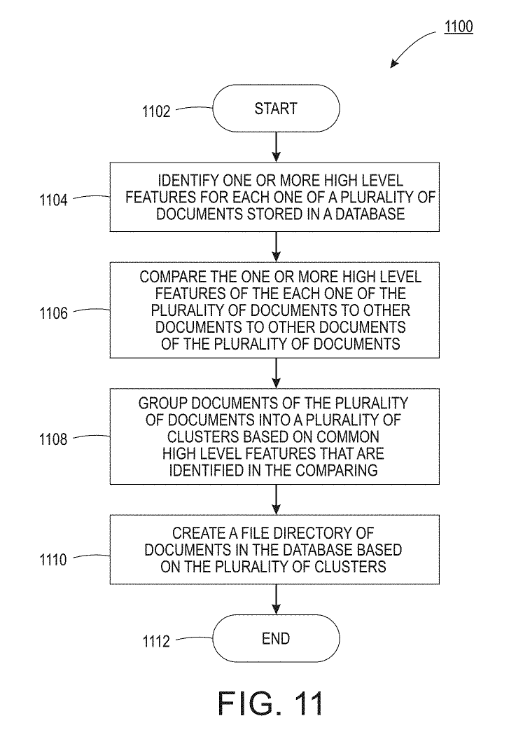

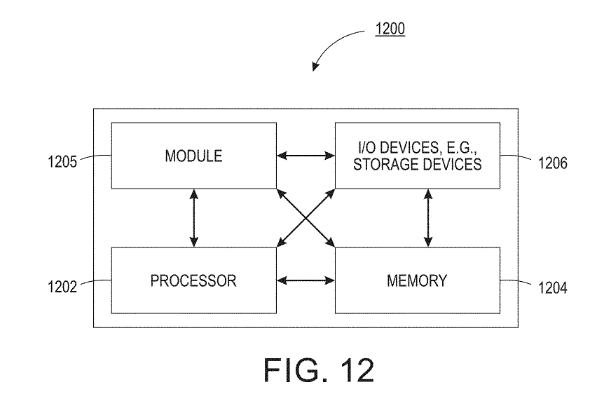

FIG. 11 illustrates a flowchart of an example method 1100 for creating a file directory of documents in a database that are clustered based on one or more high level features. In one embodiment, one or more steps or operations of the method 1100 may be performed by the endpoint device 102 or a computer as illustrated in FIG. 12 and discussed below.

At block 1102, the method 1100 begins. At block 1104, the method 1100 identifies the one or more high level features for each one of a plurality of documents stored in the database. For example, an electronic document may be rendered into a format that may be analyzed (e.g., a .png file). The rendered document may then be analyzed to extract one or more high level features, such as the high level features described above in FIGS. 3-9 using the predefined set of rules associated with each one of the high level features or a training model. As noted above, the high level features may include, for example, a spot title, an address field, a margin icon, a table, a border area, or a text flow. The predefined rules may include a size of the feature and a location of the feature relative to an origin (e.g., the upper left hand corner of the page).

In one embodiment, documents may be analyzed using a segmentation algorithm that analyzes groups of pixels within a window having a predefined size (e.g., 10 pixels×10 pixels, 100 pixels×100 pixels, and the like). When multiple possible high level features are identified within a single segment, a level of priority may be used to determine the high level feature.

At block 1106, the method 1100 compares the one or more high level features of the each one of the plurality of documents to other documents of the plurality of documents. For example, the number and type of each one of the high level features in each document may be compared to one another. The documents that share the same number of different high level features may be identified.

At block 1108, the method 1100 groups documents of the plurality of documents into a plurality of clusters based on common high level features that are identified in the comparing. For example, the documents that are identified as having the same number of different high level features may be grouped together to form a cluster. The cluster may be a subset of documents of the plurality of documents that have the same type of high level features and the same number of each type of high level features.

At optional block 1110, the method 1100 creates the file directory of documents in the database based on the plurality of clusters. In one embodiment, the file directory may include a different folder for each cluster of documents. For example, if six different clusters of documents were grouped together, then the file directory may include six different folders (e.g., one folder for each one of the six different clusters). When a user selects a folder to view in the file directory, thumbnails of the documents that provide a summary of the high level features in each respective document may be displayed. At block 1112, the method 1100 ends.

It should be noted that the blocks in FIG. 11 that recite a determining operation or involve a decision do not necessarily require that both branches of the determining operation be practiced. In other words, one of the branches of the determining operation can be deemed as an optional step. In addition, one or more steps, blocks, functions or operations of the above described method 1100 may comprise optional steps, or can be combined, separated, and/or performed in a different order from that described above, without departing from the example embodiments of the present disclosure.

FIG. 12 depicts a high-level block diagram of a computer that is dedicated to perform the functions described herein. As depicted in FIG. 12, the computer 1200 comprises one or more hardware processor elements 1202 (e.g., a central processing unit (CPU), a microprocessor, or a multi-core processor), a memory 1204, e.g., random access memory (RAM) and/or read only memory (ROM), a module 1205 for creating a file directory of documents in a database that are clustered based on one or more high level features, and various input/output devices 1206 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method(s) as discussed above is implemented in a distributed or parallel manner for a particular illustrative example, i.e., the steps of the above method(s) or the entire method(s) are implemented across multiple or parallel computers, then the computer of this figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 1205 for creating a file directory of documents in a database that are clustered based on one or more high level features (e.g., a software program comprising computer-executable instructions) can be loaded into memory 1204 and executed by hardware processor element 1202 to implement the steps, functions or operations as discussed above in connection with the example method 1100. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 1205 for creating a file directory of documents in a database that are clustered based on one or more high level features (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for creating a file directory of documents in a database that are clustered based on one or more high level features, comprising:
identifying, by a processor, the one or more high level features for each one of a plurality of documents stored in the database;
comparing, by the processor, the one or more high level features of the each one of the plurality of documents to other documents of the plurality of documents;
grouping, by the processor, documents of the plurality of documents into a plurality of clusters based on common high level features that are identified in the comparing; and
creating, by the processor, the file directory of documents in the database based on the plurality of clusters.

2. The method of claim 1, wherein the one or more high level features comprises a spot title, an address field, a margin icon, a table, a border area, or a text flow.

3. The method of claim 1, wherein the one or more high level features are identified based on a predefined set of rules.

4. The method of claim 3, wherein the predefined set of rules comprises a size of a feature and a location of the feature relative to an origin.

5. The method of claim 4, wherein the origin comprises a top left corner of the document.

6. The method of claim 3, wherein the one or more high level features comprise a pre-defined priority level.

7. The method of claim 6, wherein a feature comprising two different rules of the predefined set of rules is identified based on the pre-defined priority level.

8. The method of claim 1, wherein the identifying and the comparing is performed based on only a first page the each one of the plurality of documents.

9. The method of claim 1, wherein the documents in each one of the plurality of clusters share a same number of different high level features.

10. A non-transitory computer-readable medium storing a plurality of instructions, which when executed by a processor, cause the processor to perform operations for creating a file directory of documents in a database that are clustered based on one or more high level features, the operations comprising:
identifying the one or more high level features for each one of a plurality of documents stored in the database;
comparing the one or more high level features of the each one of the plurality of documents to other documents of the plurality of documents;
grouping documents of the plurality of documents into a plurality of clusters based on common high level features that are identified in the comparing; and
creating the file directory of documents in the database based on the plurality of clusters.

11. The non-transitory computer-readable medium of claim 10, wherein the one or more high level features comprises a spot title, an address field, a margin icon, a table, a border area, or a text flow.

12. The non-transitory computer-readable medium of claim 10, wherein the one or more high level features are identified based on a predefined set of rules.

13. The non-transitory computer-readable medium of claim 12, wherein the predefined set of rules comprises a size of a feature and a location of the feature relative to an origin.

14. The non-transitory computer-readable medium of claim 13, wherein the origin comprises a top left corner of the document.

15. The non-transitory computer-readable medium of claim 12, wherein the one or more high level features comprise a pre-defined priority level.

16. The non-transitory computer-readable medium of claim 15, wherein a feature comprising two different rules of the predefined set of rules is identified based on the pre-defined priority level.

17. The non-transitory computer-readable medium of claim 10, wherein the identifying and the comparing is performed based on only a first page the each one of the plurality of documents.

18. The non-transitory computer-readable medium of claim 10, wherein the documents in each one of the plurality of clusters share a same number of different high level features.

19. A method for creating a file directory of documents in a database that are clustered based on one or more high level features, comprising:
scanning, by a processor, a plurality of segments of each one of a plurality of documents stored in the database, wherein the plurality segments have a predefined size;
comparing, by the processor, images in each one of the plurality of segments to a plurality of predefined rules, wherein each one of the plurality of predefined rules is associated with a different high level feature;
identifying, by the processor, the one or more high level features based on the comparing for the each one of a plurality of documents;
comparing, by the processor, the one or more high level features of the each one of the plurality of documents to other documents of the plurality of documents;
grouping, by the processor, documents of the plurality of documents into a plurality of clusters, wherein the documents in each one of the plurality of clusters share a same number of different high level features that are identified based on the comparing; and
creating, by the processor, the file directory of documents in the database based on the plurality of clusters.

20. The method of claim 19, wherein the one or more high level features comprises a spot title, an address filed, a margin icon, a table, a border area, or a text flow.
